(19) United States
(12) Patent Application Publication
(10) Pub. No.: US 2025/0321687 A1
(43) Pub. Date: Oct. 16, 2025

(54) HOST-CONFIGURABLE OVERPROVISIONING

(71) Applicant: MICRON TECHNOLOGY, INC., Boise, ID (US)

(72) Inventors: Gianluca Coppola, Naples (IT); Daniela Ruggeri, Naples (IT)

(21) Appl. No.: 19/086,353

(22) Filed: Mar. 21, 2025

Related U.S. Application Data
(60) Provisional application No. 63/632,342, filed on Apr. 10, 2024.

(51) Int. Cl. G06F 3/06

(52) U.S. Cl. CPC G06F 3/0631; G06F 3/0611; G06F 3/0659; G06F 3/0673

(57) ABSTRACT

A system includes a memory device; and a processing device, operatively coupled with the memory device, to perform operations including exposing, to a host system, a plurality of values of an overprovisioning parameter of the memory device; receiving, from the host system, a selection of value of the plurality of values; and updating, based on the selection, a value of an operating parameter specifying an overprovisioned capacity of the memory device.

### RELATED APPLICATIONS

This application claims the benefit of U.S. Provisional Patent Application No. 63/632,342 filed Apr. 10, 2024, entitled “HOST-CONFIGURABLE OVERPROVISIONING”, the contents of which are incorporated by reference in its entirety herein.

### TECHNICAL FIELD

Embodiments of the disclosure relate generally to memory sub-systems, and more specifically, relate to host adjustment of preconfigured overprovisioning of a memory device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various implementations of the disclosure.

FIG. 1 illustrates an example computing environment that includes a memory sub-system in accordance with some embodiments of the present disclosure.

FIGS. 2A and 2B illustrates example registers used to implement host adjustment of preconfigured overprovisioning of a memory device in accordance with some embodiments of present disclosure.

FIGS. 3-4 are flow diagrams of example methods to implement host adjustment of preconfigured overprovisioning of a memory device in accordance with some embodiments of the present disclosure.

FIG. 5 is a block diagram of an example computer system in which implementations of the present disclosure can operate.

### DETAILED DESCRIPTION

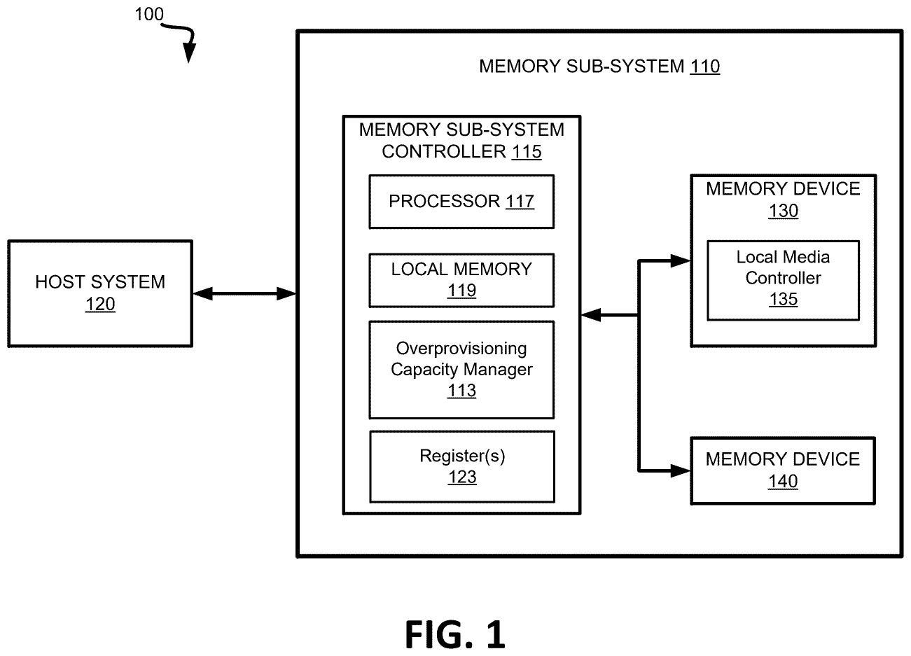

Aspects of the present disclosure are directed to host adjustment of preconfigured overprovisioning of a memory device. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, negative-and (NAND) memory offers storage in the form of compact, high density configurations. A non-volatile memory device is a package of one or more dice, each including one or more planes. For some types of non-volatile memory devices (e.g., NAND memory), each plane includes of a set of physical blocks. Each block includes of a set of pages. Each page includes of a set of memory cells (“cells”). A cell is an electronic circuit that stores information. A block hereinafter refers to a unit of the memory device used to store data and can include a group of memory cells, a word line group, a word line, or individual memory cells. Each block can include a number of sub-blocks, where each sub-block is defined by an associated pillar (e.g., a vertical conductive trace) extending from a shared bit line. Memory pages (also referred to herein as “pages”) store one or more bits of binary data corresponding to data received from the host system.

Overprovisioning refers to the physical capacity of a memory device exceeding the logical capacity that is presented through the operating system as available to a host system (“user capacity”). Thus, due to the overprovisioning, the ratio of the physical capacity of a memory device and the user capacity of the memory device would exceed one; the difference between the physical capacity and the user capacity is the overprovisioned capacity, which can be measured by a number of excess valid blocks, memory pages, sub-blocks, half-blocks, or any other management units (MUs) in a memory device. The overprovisioned capacity may be utilized, e.g., for garbage collection, wear leveling, and/or dynamic cache.

In some memory sub-systems, a memory device, such as managed NAND flash memory, embedded multimedia card (eMMC), may include a controller to manage processes and improve performance. A firmware running on the controller may use the overprovisioned capacity to support garbage collection, wear-leveling, bad block replacement, or other background processes that maintain and optimize the performance. The efficiency of such processes may depend upon the overprovisioned capacity. The overprovisioned capacity may be preconfigured at the manufacturing or post-production stage, without regard to specific usage patterns of the memory device by the host system.

Aspects of the present disclosure address the above and other deficiencies by enabling the host system to select one of the overprovisioning parameter values that may be exposed by the memory device, e.g., via an overprovisioning options register, which can be a read-only register of the configuration space of the memory device. In some implementations, a controller (e.g., a memory sub-system or a local controller of a memory device) can store, in the overprovisioning options register, a list of valid overprovisioning parameter values from which the host system may select one or more values to be utilized by the controller for configuring the overprovisioned capacity of the memory device. Thus, a host system may read the overprovisioning options register of the configuration space of the memory device and may further select an overprovisioning parameter value that represents less overprovisioned capacity (which may lead to less efficient background processes) and more user capacity, or an overprovisioning parameter value that represents more overprovisioned capacity (which may lead to more efficient background processes) and less user capacity. Therefore, the host system can select, from the list, a desired value of the specific overprovisioning parameter and send the selected value to the controller.

The controller may validate the received value, e.g., by comparing the received value to the list of valid overprovisioning parameter values. Upon failing to find the received value in the list, the controller may notify the host system of an error. Conversely, upon successfully validating the received value, the controller may, according to the received value, store an overprovisioning parameter value in an overprovisioning configuration register, which can be a read/write or write only register of the configuration space in the memory device. The memory device may check the overprovisioning configuration register, and update, according to the overprovisioning configuration register, a value of an operating parameter of the memory device to adjust the memory space allocated as the overprovisioned capacity. For example, the controller may update an operating parameter stored in a register of the memory device (e.g., SEC_COUNT field in extend device-specific data (CSD) register, where the SEC_COUNT field defines the user capacity of the memory device) to adjust the memory space allocated as the overprovisioned capacity.

Advantages of the present disclosure include enabling a host system to effectively adjust a preconfigured overprovisioned capacity of the memory device, in order to flexibly balance between performance and user capacity. The present disclosure satisfies a demand for the host system to adjust the preconfigured overprovisioned capacity in view of the usage need of the host system. In some usages of the memory device, a host system may require larger overprovisioned capacity for a better performance. Larger overprovisioned capacity may provide additional available memory to the firmware to optimize the internal data management, resulting in performance improvement or endurance improvement. For example, the firmware may engage in “light” garbage collection due to the number of free blocks in a larger overprovisioned capacity, and light garbage collection can increase effective over-provisioning, lead to write amplification reduction, minimize performance degradation, and result in lesser device wear out through the life of memory device. In some usages of the memory device, a host system may require large user capacity to store user data.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory devices (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLCs) can store one bit per cell. Other types of memory cells, such as multi-level cells (MLCs), triple level cells (TLCs), quad-level (QLCs), and penta-level cells (PLCs) cells, can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion and a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory devices such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

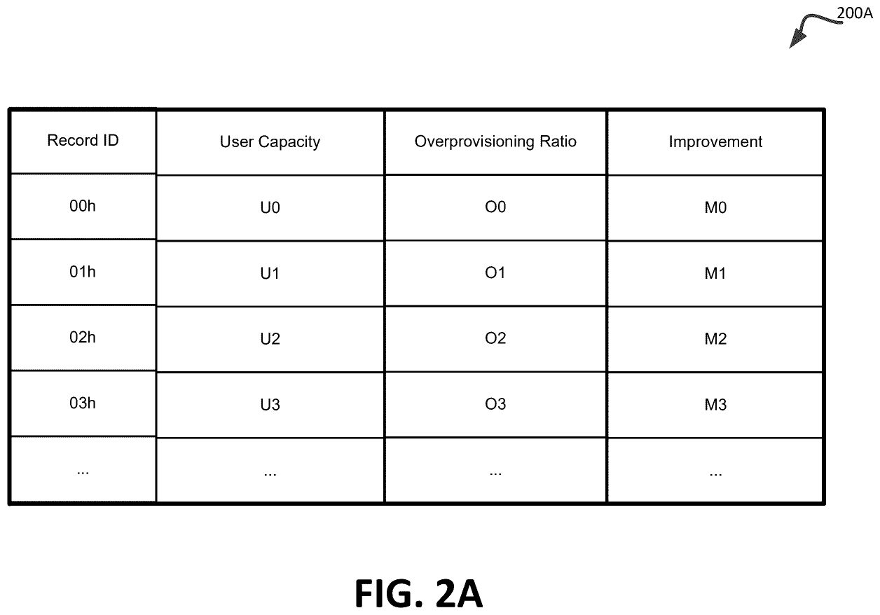

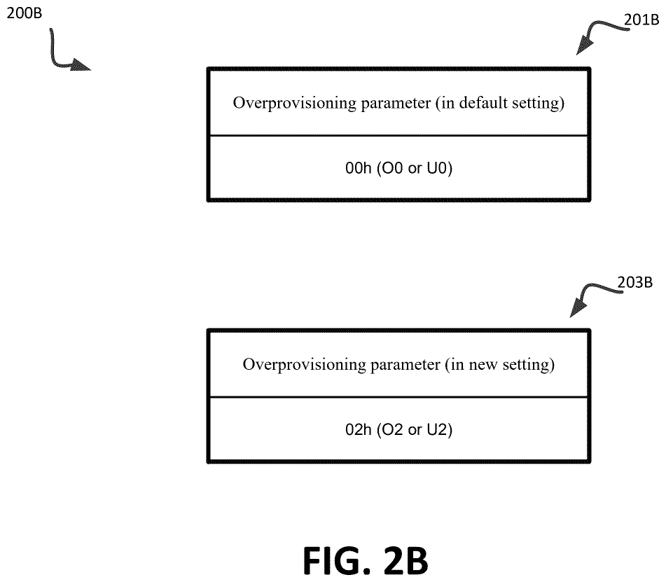

The memory sub-system 110 includes overprovisioning capacity manager 113 that can enable host adjustment of preconfigured overprovisioning of a memory device. The memory sub-system 110 may include configuration space register(s) 123 used to support the operations and functionality of the overprovisioning capacity manager 113 described herein. Further details with regards to the operations of the overprovisioning capacity manager 113 and the register(s) 123 are described with respect to FIGS. 2A-5.

FIGS. 2A and 2B illustrate example registers (e.g., register(s) 123) used to implement host adjustment of preconfigured overprovisioning of a memory device in accordance with some embodiments of present disclosure. FIG. 2A illustrates a read-only register (i.e., an overprovisioning options register) that can be used to store a list of valid overprovisioning parameter values, for example, register 200A. FIG. 2B illustrates a read/write (R/W) register (i.e., an overprovisioning configuration register) that can be used to store a valid overprovisioning parameter value (e.g., from a value shown in register 201B to a value shown in register 203B), which can be used by the memory device to update the preconfigured overprovisioning of the memory device.

Referring to FIG. 2A, the register 200A (i.e., an overprovisioning options register) stores the list of valid overprovisioning parameter values, and the list includes multiple entries. In an illustrative example, each entry of the list may include the overprovisioning parameter value represented by the user capacity (e.g., measured by numbers of MUs). In an illustrative example, each entry of the list may include the overprovisioning parameter value represented by the overprovisioning ratio (e.g., measured by a ratio of physical capacity to user capacity). In some implementations, each entry of the list may include values of two or more overprovisioning parameters (e.g., the overprovisioning ratio and the corresponding user capacity). In some implementations, each entry of the list may also specify a corresponding predicted improvement in performance of the memory device or in endurance of the memory device. The predicted improvement may be measured by a ratio of a specific parameter associated with the corresponding overprovisioning parameters (referred to as new setting of overprovisioning parameters) to the same parameter associated with default overprovisioning parameters (referred to as default setting of overprovisioning parameters). The default setting of overprovisioning parameters may be the overprovisioning parameters (e.g., the overprovisioning ratio, the user capacity, etc.) set during the manufacturing and/or post-production stage.

For example, the predicted improvement may be measured by a ratio of the performance parameter in the new setting to the performance parameter in the default setting. In some implementations, the performance parameter may include a performance metric. As another example, the predicted improvement may be measured by a ratio of the endurance parameter in the new setting to the endurance parameter in the default setting. In some implementations, the endurance parameter may include the terabyte written (TBW) capability, which refers to an amount of data that can be written to a memory device over the lifespan of the memory device. The list in register 200A may be pre-populated during the manufacturing or post-production stage.

In some implementations, each entry of the list may be represented by a record identifier or indexed in the list. For example, an entry, e.g., record ID 00h, may indicate a default setting that corresponds to the user capacity U0 and the overprovisioning ratio 00. For example, assuming the physical capacity is PC, the user capacity is U0, and the overprovisioning ratio is O0=PC/U0. The performance parameter is PPO, and the endurance parameter is EP0. The improvement metric M0 is 0% because it corresponds to the default setting.

In some implementations, the predicted improvement metric may be measured by a percentage of a performance parameter in the new setting with respect to the performance parameter in the default setting. For example, record ID 01h may indicate the new setting that corresponds to the user capacity U1 and the overprovisioning ratio O1. Assuming the physical capacity is PC, the user capacity is U1, the overprovisioning ratio is O1=PC/U1, and the performance parameter is PP1. The improvement metric M1 is (PP1−PP0)/PP0.

In some implementations, the predicted improvement metric may be measured by a percentage of the endurance parameter in the new setting with respect to the performance parameter in the default setting. For example, record ID 02h may indicate the new setting that corresponds to the user capacity U2 and the overprovisioning ratio O2. Assuming the physical capacity is PC, the user capacity is U2, the overprovisioning ratio is O2=PC/U2, and the endurance parameter is EP2. The improvement metric M2 is (EP2−EP0)/EP0.

Referring to FIG. 2B, the overprovisioning capacity manager 113 may modify the register (i.e., an overprovisioning configuration register) from the value in a default setting (e.g., shown as register 201B) to the value in a new setting (e.g., shown as register 203B). The register 201B may store a value of an overprovisioning parameter corresponding to the default setting. For example, the overprovisioning parameter value may be preset as a value of the user capacity corresponding to the record ID 00h. As another example, the overprovisioning parameter value may be preset as a value of the overprovisioning ratio corresponding to the record ID 00h. As yet another example, the overprovisioning parameter value may be preset as the record ID 00h, which can be used to read in the register 200A for a specific value of the user capacity or the overprovisioning ratio of the entry.

The register 203B may store a value of an overprovisioning parameter corresponding to the new setting. For example, the overprovisioning parameter value may be modified to a value of the user capacity corresponding to the record ID 02h. As another example, the overprovisioning parameter value may be modified to a value of the overprovisioning ratio corresponding to the record ID 02h. As yet another example, the overprovisioning parameter value may be modified to the record ID 02h, which can be used to read in the register 200A for a specific value of the user capacity or the overprovisioning ratio of the entry.

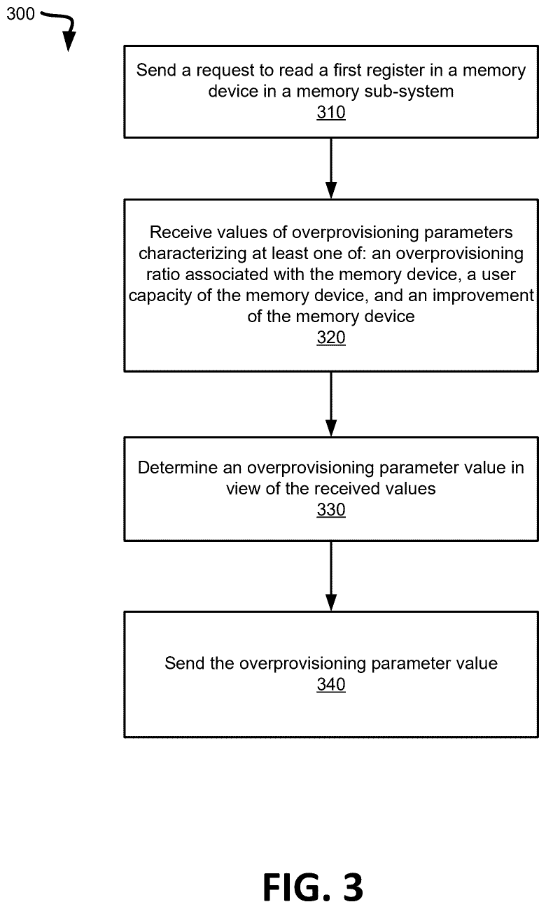

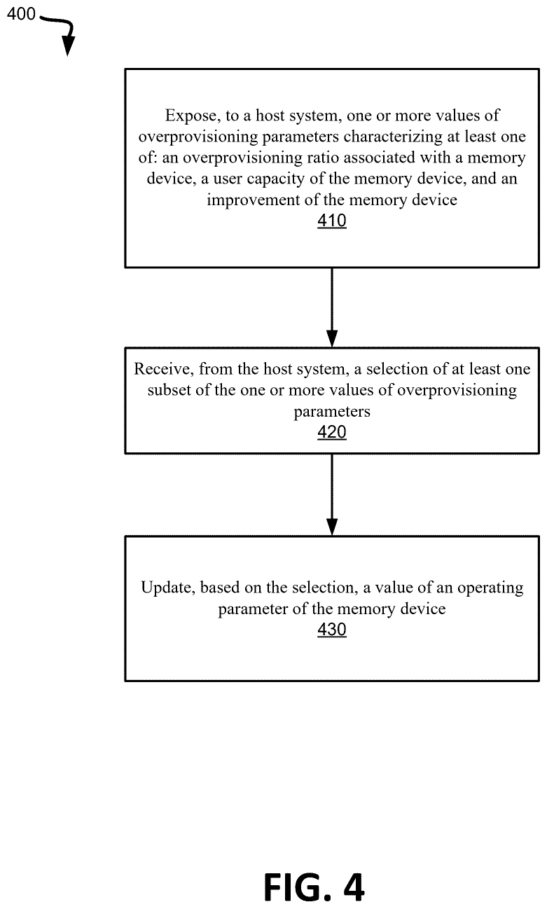

FIGS. 3-4 are flow diagrams of example methods to implement host adjustment of preconfigured overprovisioning of a memory device, in accordance with some embodiments of the present disclosure. The methods 300-400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the host system 120 (e.g., a controller or a CPU in the host system 120), and the method 400 is performed by the overprovisioning capacity manager 113 (or a controller of the memory sub-system 110 or a local controller in the memory device 130) of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 3, at operation 310, the processing logic in the host system (e.g., host system 120) may send, to a memory device (e.g., memory device 130), a request to read a first register (e.g., register 200A in register(s) 123) in the memory device in a memory sub-system. In some implementations, the first register stores a list including one or more values of overprovisioning parameters characterizing at least one of: an overprovisioning ratio associated with the memory device, a user capacity of the memory device, and an improvement of the memory device. In some implementations, the first register is in a configuration space of the memory device. In some implementations, the first register is a read-only register.

At operation 320, responsive to sending the request, the processing logic in the host system may receive, from the memory device (e.g., via the overprovisioning capacity manager 113), the values of overprovisioning parameters characterizing at least one of: an overprovisioning ratio associated with the memory device, a user capacity of the memory device, and an improvement of the memory device. In some implementations, the values of overprovisioning parameters are preset in the first register (e.g., set during manufacturing or post-production stage of the memory device, by a vendor of the memory device).

At operation 330, the processing logic in the host system may determine an overprovisioning parameter value in view of the received values. In some implementations, the processing logic may determine an overprovisioning parameter value by selecting at least one subset of the one or more values of overprovisioning parameters (e.g., selecting one entry of the entries in 200A). For example, one subset of the one or more values of overprovisioning parameters includes a value indicating a user capacity, a value indicating an overprovisioning ratio, and a value indicating a predicted improvement, and the processing logic may select the subset that includes a desired improvement and determine an overprovisioning parameter value as a value indicating a user capacity or a value indicating an overprovisioning ratio in the subset. Using the example illustrated in FIG. 2A, the processing logic may select the record ID 03h as the entry includes the desired improvement M3, and thus determine an overprovisioning parameter value as user capacity U3 or overprovisioning ratio O3 associated with the record ID 03h.

At operation 340, the processing logic in the host system may send, to the memory device (e.g., memory device 130), the determined overprovisioning parameter value. In some implementations, the processing logic may send the selected at least one subset of the one or more values of overprovisioning parameters. For example, one subset of the one or more values of overprovisioning parameters includes a value indicating a user capacity, a value indicating an overprovisioning ratio, and a value identifying the subset, and the processing logic may send one or more of these values. Using the example illustrated in FIG. 2A, the processing logic may send the record ID 03h, or user capacity U3 or overprovisioning ratio O3 associated with the record ID 03h.

Referring to FIG. 4, at operation 410, the processing logic (e.g., the overprovisioning capacity manager 113) may expose, to a host system (e.g., the host system 120), one or more values of overprovisioning parameters characterizing at least one of: an overprovisioning ratio associated with the memory device (e.g., memory device 130), a user capacity of the memory device, and an improvement of the memory device. In some implementations, the processing logic may expose one or more values of overprovisioning parameters in response to receiving a request (e.g., operation 310) from the host system such that the operation 410 may correspond to operation 320. In some implementations, a first register (e.g., register 200A in register(s) 123) stores a list including one or more values of overprovisioning parameters characterizing at least one of: an overprovisioning ratio associated with the memory device, a user capacity of the memory device, and an improvement of the memory device. In some implementations, the first register is in a configuration space of the memory device (e.g., memory device 130). In some implementations, the first register is a read-only register. In some implementations, the one or more values of overprovisioning parameters are preset according to historical data.

In some implementations, the improvement of the memory device is measured by at least one of: a performance metric, or a terabyte written capacity. In some implementations, a value of the overprovisioning parameter characterizing the improvement of the memory device is a percentage of the performance or endurance parameter in a new setting of overprovisioning of the memory device with respect to a default setting of overprovisioning of the memory device.

At operation 420, the processing logic may receive, from the host system, a selection of at least one subset of the one or more values of overprovisioning parameters. In some implementations, the selection includes a second value (e.g., operation 340), and the processing logic may determine whether the second value is valid according to the one or more values of overprovisioning parameters. In some implementations, the processing logic may search the first register (e.g., register 200A in register(s) 123) for a match of the second value, determine the second value is valid when a match of the second value is found, and determine that the second value is not valid when a match of the second value is not found. In some implementations, the processing logic determines whether the second value matches a value in the one or more values of overprovisioning parameters. In some implementations, responsive to determining that the second value is valid, the processing logic may write the second value to a second register. In some implementations, responsive to determining that the second value is not valid, the processing logic may send an error notification to the host system in response to receiving the second value (or the selection).

Using the example illustrated in FIGS. 2A and 2B, the processing logic may receive the second value as the record ID 02h, or user capacity U2 or overprovisioning ratio O2 associated with the record ID 02h, and search the first register 220A for a match of the second value, and determine that the second value is valid as a match is found. In some implementations, responsive to determining that the second value is valid, the processing logic may write the second value to a second register 200B by modifying from the value 00h (O0 or U0) of the second register 201B to the value 02h (O2 or U2) of the second register 203B.

In some implementations, the second value is chosen from the one or more values of overprovisioning parameters. In some implementations, writing the second value to the second register is performed one-time during a lifetime of the memory device. In some implementations, the second value indicates at least one of: the overprovisioning ratio or the user capacity.

At operation 430, the processing logic may update, based on the selection, a value of an operating parameter of the memory device. In some implementations, the processing logic may update the value of the operating parameter of the memory device by a firmware running on the processing device. In some implementations, the firmware runs on a controller of the memory device, and the firmware uses an overprovisioned capacity of the memory device.

In some implementations, the processing logic may update a value of an operating parameter of the memory device by first writing the second value in a second register (e.g., register 200B in register(s) 123) and then updating the value of the operating parameter according to the second value written in the second register. Using the example illustrated in FIG. 2B, the second value is user capacity U2 or overprovisioning ratio O2, and the processing logic may update the value of an operating parameter of the memory device to be aligned with the user capacity U2 or overprovisioning ratio O2.

In some implementations, the operating parameter may specify at least one of: the overprovisioned capacity of the memory device, the user capacity of the memory device, or the overprovisioning ratio of the memory device. In some implementations, the value of the operating parameter (e.g., SEC_COUNT parameter) is stored in a third register (e.g., extend device-specific data (CSD) register), and wherein the operating parameter specifies the user capacity of the memory device. In some implementations, the processing logic may update the value of an operating parameter of the memory device by decreasing the user capacity of the memory device, where the physical capacity of the memory device is unchanged.

In some implementations, the value of the operating parameter is stored in another register, and wherein the operating parameter specifies the overprovisioned capacity of the memory device. In some implementations, the processing logic may update the value of an operating parameter of the memory device by increasing the overprovisioned capacity of the memory device, where a physical capacity of the memory device is unchanged.

In some implementations, the value of the operating parameter is stored in another register, and wherein the operating parameter specifies the overprovisioning ratio of the memory device. In some implementations, the processing logic may update the value of an operating parameter of the memory device by increasing the overprovisioning ratio of the memory device, where a physical capacity of the memory device is unchanged.

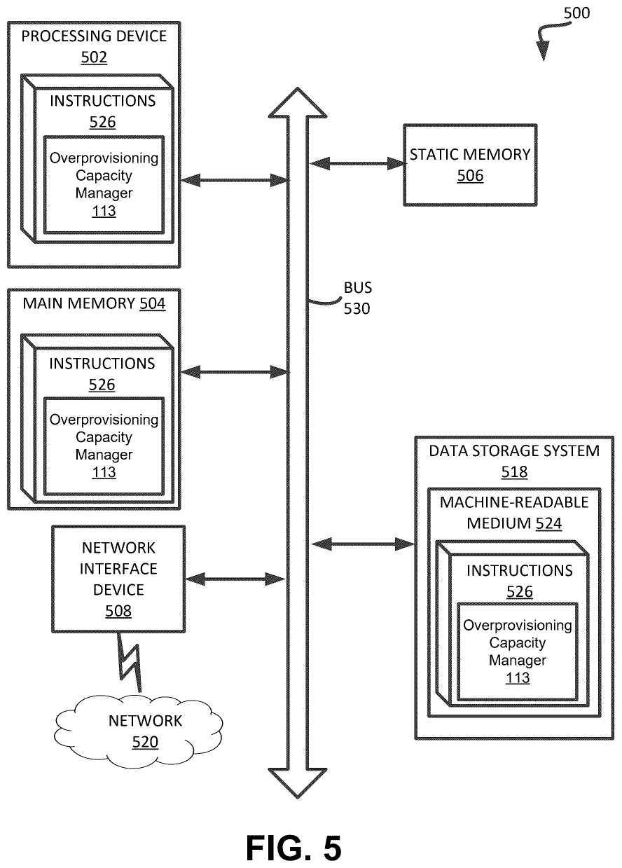

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the overprovisioning capacity manager 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a data relocation component (e.g., the overprovisioning capacity manager 113 of FIG. 1). While the machine-readable storage medium 524 is shown For example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled with the memory device, to perform operations comprising:
exposing, to a host system, a plurality of values of an overprovisioning parameter of the memory device;
receiving, from the host system, a selection of value of the plurality of values; and
updating, based on the selection, a value of an operating parameter specifying an overprovisioned capacity of the memory device.

2. The system of claim 1, wherein the overprovisioning parameter characterizes at least one of: an overprovisioning ratio associated with the memory device, a user capacity of the memory device, or an improvement of a performance metric of the memory device.

3. The system of claim 1, wherein the plurality of values of the overprovisioning parameter are stored in a first register of a configuration space of the memory device, wherein the first register is read-only.

4. The system of claim 1, wherein receiving the selection of value of the plurality of values further comprises:
receiving a second value from the host system;
determining whether the second value is valid according to the plurality of values of the overprovisioning parameter; and
responsive to determining that the second value is valid, writing the second value to a second register of a configuration space of the memory device, wherein updating the value of an operating parameter is performed according to the second value written in the second register.

5. The system of claim 4, wherein determining whether the second value is valid further comprises:
determining whether the second value matches a value in the plurality of values of the overprovisioning parameter plurality of values of the overprovisioning parameter.

6. The system of claim 4, wherein the operations further comprises:
responsive to determining that the second value is not valid, sending an error notification to the host system in response to receiving the second value.

7. The system of claim 1, wherein the value of the operating parameter is stored in a third register.

8. The system of claim 1, wherein the operating parameter specifying the overprovisioned capacity comprises at least one of: a parameter specifying a user capacity of the memory device, or a parameter specifying an overprovisioning ratio of the memory device.

9. The system of claim 1, wherein updating the value of the operating parameter further comprises:
decreasing a user capacity of the memory device, wherein a physical capacity of the memory device is unchanged.

10. A method comprising:
exposing, by a processing device, to a host system, a plurality of values of an overprovisioning parameter of the memory device;
receiving, from the host system, a selection of value of the plurality of values; and
updating, based on the selection, a value of an operating parameter specifying an overprovisioned capacity of the memory device.

11. The method of claim 10, wherein the overprovisioning parameter characterizes at least one of: an overprovisioning ratio associated with the memory device, a user capacity of the memory device, or an improvement of a performance metric of the memory device.

12. The method of claim 10, wherein the plurality of values of the overprovisioning parameter are stored in a first register of a configuration space of the memory device, wherein the first register is read-only, and wherein the plurality of values of the overprovisioning parameter are preset.

13. The method of claim 10, wherein receiving the selection of value of the plurality of values further comprises:
receiving a second value from the host system;
determining whether the second value is valid according to the plurality of values of the overprovisioning parameter; and
responsive to determining that the second value is valid, writing the second value to a second register of a configuration space of the memory device, wherein updating the value of an operating parameter is performed according to the second value written in the second register.

14. The method of claim 10, wherein the value of the operating parameter is stored in a third register.

15. The method of claim 10, wherein the operating parameter specifying the overprovisioned capacity comprises at least one of: a parameter specifying a user capacity of the memory device, or a parameter specifying an overprovisioning ratio of the memory device.

16. A non-transitory computer-readable storage medium comprising instructions that, when executed by a processing device, cause the processing device to perform operations comprising:
exposing, to a host system, a plurality of values of an overprovisioning parameter of the memory device;
receiving, from the host system, a selection of value of the plurality of values; and
updating, based on the selection, a value of an operating parameter specifying an overprovisioned capacity of the memory device.

17. The non-transitory computer-readable storage medium of claim 16, wherein the overprovisioning parameter characterizes at least one of: an overprovisioning ratio associated with the memory device, a user capacity of the memory device, or an improvement of a performance metric of the memory device.

18. The non-transitory computer-readable storage medium of claim 16, wherein the plurality of values of the overprovisioning parameter are stored in a first register of a configuration space of the memory device, wherein the first register is read-only.

19. The non-transitory computer-readable storage medium of claim 16, wherein receiving the selection of value of the plurality of values further comprises:
receiving a second value from the host system;
determining whether the second value is valid according to the plurality of values of the overprovisioning parameter; and
responsive to determining that the second value is valid, writing the second value to a second register of a configuration space of the memory device, wherein updating the value of an operating parameter is performed according to the second value written in the second register.

20. The non-transitory computer-readable storage medium of claim 16, wherein the value of the operating parameter is stored in a third register.
